(19) United States
(12) Patent Application Publication
(10) Pub. No.: US 2026/0119913 A1
(43) Pub. Date: Apr. 30, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventor: Koyo TATE, Tokyo (JP)

(73) Assignee: NEC Corporation, Tokyo (JP)

(21) Appl. No.: 19/355,077

(22) Filed: Oct. 10, 2025

(30) Foreign Application Priority Data
Oct. 31, 2024 (JP) 2024-192247

(51) Int. Cl. G06N 5/022

(52) U.S. Cl. CPC G06N 5/022

(57) ABSTRACT

An information processing apparatus includes at least one memory storing instructions, and at least one processor configured to execute the instructions to acquire target data, generate a knowledge graph from the target data, perform machine learning on the knowledge graph, calculate similarity between a plurality of nodes included in the machine-learned knowledge graph, generate a property graph with reference to the calculated similarity, and estimate a feature vector of at least one node included in the property graph by executing embedding propagation with reference to the property graph.

### INCORPORATION BY REFERENCE

This application is based upon and claims the benefit of priority from Japanese patent application No. 2024-192247, filed on Oct. 31, 2024, the disclosure of which is incorporated herein in its entirety by reference.

### TECHNICAL FIELD

The present disclosure relates to an information processing apparatus, an information processing method, and a non-transitory computer readable medium.

### BACKGROUND ART

A technique called embedding propagation (EP) for learning embedding (vectorization) of data, an instance, or the like based on a graph structure representing a relationship between the data and the instance is known (Alberto Garcia-Duran and Mathias Niepert, “Learning Graph Representations with Embedding Propagation”, arXiv:1710.03059, October 2017).

### SUMMARY

In a case where the embedding propagation described in “Learning Graph Representations with Embedding Propagation” (Alberto Garcia-Duran and Mathias Niepert, arXiv:1710.03059, October 2017) is used, it is possible to enjoy a merit that it is possible to generate useful embedding with respect to a missing value as compared with a simple complementing method. On the other hand, in a case where a graph structure is not given to data to be analyzed, it is necessary to suitably generate the graph structure so that the embedding propagation can be applied to the data to be analyzed.

The present disclosure has been made in view of the above problems, and an example object thereof is to provide a technique capable of generating a suitable graph structure from target data.

An information processing apparatus according to an example aspect of the present disclosure includes at least one memory storing instructions, and at least one processor configured to execute the instructions to acquire target data, generate a knowledge graph from the target data, perform machine learning on the knowledge graph, calculate similarity between a plurality of nodes included in the machine-learned knowledge graph, generate a property graph with reference to the calculated similarity, and estimate a feature vector of at least one node included in the property graph by executing embedding propagation with reference to the property graph.

An information processing method according to an example aspect of the present disclosure causes one or more processors to execute acquiring target data, generating a knowledge graph from the target data, machine-learning the knowledge graph, calculating similarity between a plurality of nodes included in the machine-learned knowledge graph, generating a property graph with reference to the calculated similarity, and estimating a feature vector of at least one mode included in the property graph by executing embedding propagation with reference to the property graph.

A non-transitory computer-readable medium according to an example aspect of the present disclosure stores a program for causing a computer to execute processing comprising: acquiring target data, generating a knowledge graph from the target data, performing machine learning on the knowledge graph, calculating similarity between a plurality of nodes included in the machine-learned knowledge graph, generating a property graph with reference to the calculated similarity, and estimating a feature vector of at least one node included in the property graph by executing embedding propagation with reference to the property graph.

The information processing apparatus according to each aspect of the present disclosure may be implemented by a computer, and in this case, a program that causes the computer to operate as each unit (software element) included in the information processing apparatus to implement the information processing apparatus by the computer, and a computer-readable recording medium recording the program are also included in the scope of the present disclosure.

According to an example aspect of the present disclosure, there is an exemplary effect that a suitable graph structure can be generated from target data.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a flowchart illustrating a flow of an information processing method according to the present disclosure;

FIG. 5 is a diagram for explaining generation processing of a knowledge graph according to the present disclosure;

FIG. 6 is a diagram for explaining a process of learning a knowledge graph according to the present disclosure;

FIG. 7 is a diagram for explaining a process of generating a property graph according to the present disclosure;

FIG. 8 is a diagram for explaining processing in the information processing apparatus according to the present disclosure;

FIG. 9 is a block diagram illustrating a configuration of an information processing system according to the present disclosure;

FIG. 10 is a diagram for explaining an application of the information processing system according to the present disclosure;

FIG. 11 is a diagram for explaining a display example by the information processing system according to the present disclosure; and

FIG. 12 is a block diagram illustrating a hardware configuration of the information processing apparatus according to the present disclosure.

### EXAMPLE EMBODIMENT

Hereinafter, example embodiments of the present disclosure will be exemplified. However, the present disclosure is not limited to the exemplary example embodiments described below, and various modifications can be made within the scope described in the claims. For example, example embodiments obtained by appropriately combining technical means adopted in the following exemplary example embodiments can also be included in the scope of the present disclosure. Example embodiments obtained by appropriately omitting some of the technical means adopted in the following exemplary example embodiments can also be included in the scope of the present disclosure. Effects mentioned in the following exemplary example embodiments are examples of effects expected in the exemplary example embodiments, and do not define the extension of the present disclosure. In other words, example embodiments that do not provide the effects mentioned in the following exemplary example embodiments can also be included in the scope of the present disclosure.

### First Example Embodiment

A first exemplary example embodiment that is an example of an example embodiment of the present disclosure will be described in detail with reference to the drawings. The present exemplary example embodiment is a basic form of each exemplary example embodiment described below. An application range of each technical means adopted in the present exemplary example embodiment is not limited to the present exemplary example embodiment. That is, each technical means adopted in the present exemplary example embodiment can also be adopted in other exemplary example embodiments included in the present disclosure as long as no particular technical problem occurs. Each technical means illustrated in the drawings referred to for describing the present exemplary example embodiment can also be adopted in other exemplary example embodiments included in the present disclosure as long as no particular technical problem occurs.

### (Configuration of Information Processing Apparatus 1)

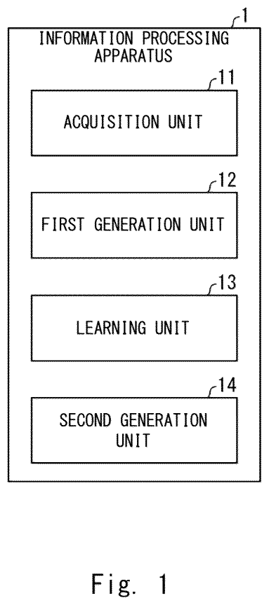

A configuration of an information processing apparatus 1 according to the present exemplary example embodiment will be described with reference to FIG. 1. FIG. 1 is a block diagram illustrating a configuration of the information processing apparatus 1. The information processing apparatus 1 may also be referred to as a graph generation apparatus, a learning apparatus, or the like. As illustrated in FIG. 1, the information processing apparatus 1 includes an acquisition unit 11, a first generation unit 12, a learning unit 13, and a second generation unit 14.

### (Acquisition Unit 11)

The acquisition unit 11 acquires target data. Here, the target data may include, as an example, data related to one or more subjects, but this does not limit the present example embodiment. The target data may include one or a plurality of pieces of text data.

### (First Generation Unit 12)

The first generation unit 12 generates a knowledge graph from the target data acquired by the acquisition unit 11. Here, the knowledge graph is a graph including a plurality of nodes and one or a plurality of links connecting the plurality of nodes, and as an example, has a plurality of types as links and nodes. The knowledge graph may be configured to include a directed link or may be configured to include an undirected link. In the knowledge graph, as an example, a node does not have an attribute value other than a label. However, these examples are not intended to limit the present exemplary example embodiment.

Although the specific generation processing of the knowledge graph by the first generation unit 12 is not limited to the present exemplary example embodiment, as an example, named entity recognition (NER) and relational extraction (RE) may be applied to one or a plurality of texts included in the target data acquired by the acquisition unit 11, and the knowledge graph may be generated with reference to the results of these processing. The generation of the knowledge graph may be expressed as construction of the knowledge graph.

### (Learning Unit 13)

The learning unit 13 learns the knowledge graph generated by the first generation unit 12. As an example, the learning unit 13 performs machine learning on the knowledge graph generated by the first generation unit 12 by applying knowledge graph embedding to the knowledge graph. Here, in knowledge graph embedding,
Referring to triple (h, r, t)=(head-node, link, tail-node), which is the minimum unit constituting the target knowledge graph,
Each node and each link are represented (vectorized) by a vector, and a method of vectorization is learned so that vectors v_{h,r} representing the head-node and the link approach a vector vₜ representing the tail-node.

Here, the vectors v_{h,r} can be expressed as v_{h,r}=vₕ+vᵣ using a vector vₕ representing the head-node and a vector vᵣ representing a link (relation).

Hereinafter, a vector representing each node and each link generated by knowledge graph embedding is also referred to as an embedding vector.

### (Second Generation Unit 14)

The second generation unit 14 generates a property graph with reference to the knowledge graph learned by the learning unit 13. As an example, the second generation unit 14 generates a property graph with reference to an embedding vector indicated by the knowledge graph learned by the learning unit 13. Here, the property graph includes, as an example,
a plurality of nodes of the same type, each node having one or a plurality of attribute values, and
one or a plurality of links connecting the plurality of nodes.

However, this configuration does not limit the present exemplary example embodiment.

Although the specific generation processing of the property graph by the second generation unit 14 does not limit the present exemplary example embodiment, as an example, the second generation unit 14 performs:
calculating similarity between a plurality of nodes included in the knowledge graph machine-learned by the learning unit 13; and
generating the property graph with reference to the calculated similarity. Here, more specifically, the similarity is calculated with reference to an embedding vector representing each of a plurality of nodes included in the knowledge graph. However, these examples are not intended to limit the present exemplary example embodiment.

### (Effects of Information Processing Apparatus 1)

As described above, the information processing apparatus 1 employs a configuration including:
acquiring target data;
generating a knowledge graph from the target data;
performing machine learning on the knowledge graph; and
generating a property graph with reference to the machine-learned knowledge graph. According to the above configuration, since the knowledge graph is generated from the target data, the generated knowledge graph is subjected to machine learning, and the property graph is generated with reference to the machine-learned knowledge graph, it is possible to generate the property graph suitably reflecting the relationship between the entities included in the target data. The property graph generated in this way can be suitably referred to in the embedding propagation.

### (Flow of Information Processing Method S1)

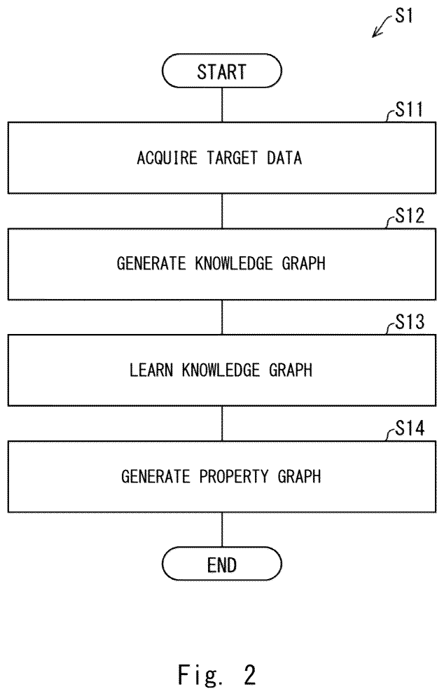

Next, a flow of an information processing method S1 according to the present exemplary example embodiment will be described with reference to FIG. 2. FIG. 2 is a flowchart illustrating the flow of the information processing method S1. As illustrated in FIG. 2, the information processing method S1 includes a step (process) S11 of acquiring target data, a step (process) S12 of generating a knowledge graph, a step (process) S13 of learning the knowledge graph, and a step (process) S14 of generating a property graph.

### (Step S11)

In step S11, the acquisition unit 11 acquires target data. Since specific processing performed by the acquisition unit 11 has been described above, the description thereof will be omitted here.

### (Step S12)

Subsequently, in step S12, the first generation unit 12 generates a knowledge graph from the target data acquired in step S11. Since specific processing performed by the first generation unit 12 has been described above, the description thereof will be omitted here.

### (Step S13)

Subsequently, in step S13, the learning unit 13 learns the knowledge graph generated in step S12. Since specific processing performed by the learning unit 13 has been described above, the description thereof will be omitted here.

### (Step S14)

Subsequently, in step S14, the second generation unit 14 generates a property graph with reference to the knowledge graph learned in step S13. Since specific processing performed by the second generation unit 14 has been described above, the description thereof will be omitted here.

### (Effects of Information Processing Method S1)

As described above, the information processing method S1 employs a configuration including:
acquiring target data;
generating a knowledge graph from the target data;
performing machine learning on the knowledge graph; and
generating a property graph with reference to the machine-learned knowledge graph. With the above configuration, effects similar to those of the information processing apparatus 1 are obtained.

### Second Example Embodiment

A second exemplary example embodiment that is an example of an example embodiment of the present disclosure will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technology illustrated in each of the drawings referred to for describing the present exemplary example embodiment can also be adopted in another exemplary example embodiment included in the present disclosure within a range in which no particular technical problem occurs.

### (Configuration of Information Processing System 100A)

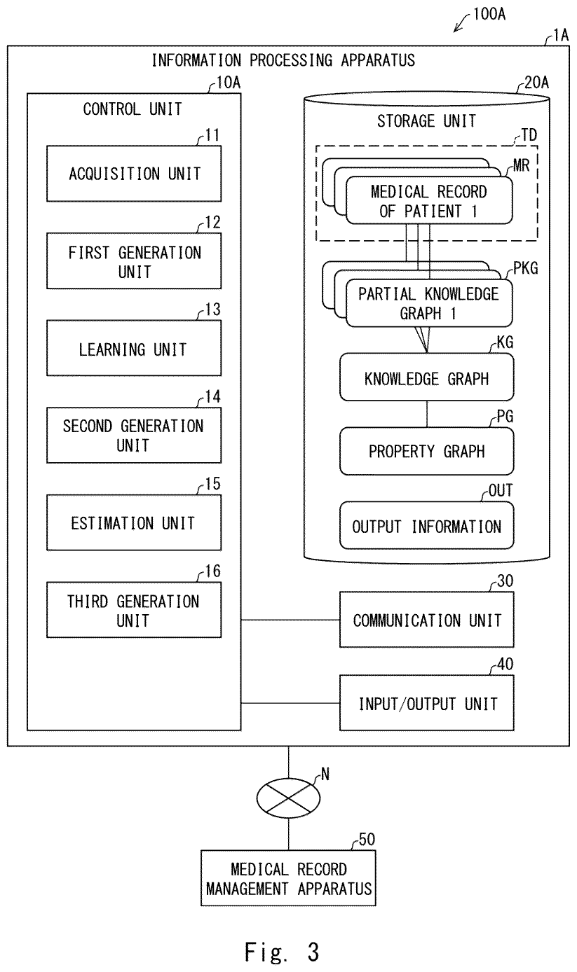

A configuration of an information processing system 100A according to the present exemplary example embodiment will be described with reference to FIG. 3. FIG. 3 is a block diagram illustrating a configuration of the information processing system 100A. As illustrated in FIG. 3, the information processing system 100A includes an information processing apparatus 1A and a medical record management apparatus 50 connected to the information processing apparatus 1A via a network N. Here, the specific configuration of the network N is not limited to the present exemplary example embodiment, but as an example, a wireless local area network (LAN), a wired LAN, a wide area network (WAN), a public line network, a mobile data communication network, or a combination of these networks can be used.

In the present exemplary example embodiment, the medical record management apparatus 50 is described as an example of the configuration for providing the target data, but this is not intended to limit the present exemplary example embodiment, and other apparatuses may be used as the configuration for providing the target data.

### (Medical Record Management Apparatus 50)

The medical record management apparatus 50 manages electronic medical records of a plurality of subjects (patient, clinical trial candidate). The electronic medical record of each subject includes:
structural data indicating a structure of information included in the electronic medical record; and
text data including one or a plurality of texts.

As an example, the text data is referred to by the information processing apparatus 1A as target data TD to be described later.

### (Configuration of Information Processing Apparatus 1A)

Next, a configuration of the information processing apparatus 1A according to the present exemplary example embodiment will be described with reference to FIG. 3. FIG. 3 is a block diagram illustrating the configuration of the information processing apparatus 1A. As illustrated in FIG. 3, the information processing apparatus 1A includes a control unit 10A, a storage unit 20A, a communication unit 30, and an input/output unit 40.

### (Communication Unit 30)

The communication unit 30 communicates with an external apparatus of the information processing apparatus 1A via a network N. As an example, the communication unit 30 transmits data supplied from the control unit 10A to the external apparatus, and supplies data received from the external apparatus to the control unit 10A. More specifically, the communication unit 30 acquires electronic medical records of a plurality of subjects from the medical record management apparatus 50.

### (Input/Output Unit 40)

The input/output unit 40 includes at least one of input/output apparatuses such as a keyboard, a mouse, a display, a printer, and a touch panel. Alternatively, input/output devices such as a keyboard, a mouse, a display, a printer, and a touch panel may be connected to the input/output unit 40. In the case of this configuration, the input/output unit 40 receives inputs of various types of information to the information processing apparatus 1A from a connected input device. The input/output unit 40 outputs various types of information to a connected output device under the control of the control unit 10A. Examples of the input/output unit 40 include an interface such as, for example, a universal serial bus (USB).

### (Storage Unit 20A)

The storage unit 20A stores various types of data referred to by the control unit 10A and various types of data generated by the control unit 10A. As an example, the storage unit 20A stores:
Target data TD;
Partial knowledge graph PKG;
Knowledge graph KG;
Property graph PG;
Output information OUT; and the like. Here, the target data TD includes text data included in the electronic medical record of each of the plurality of subjects described above. The partial knowledge graph PKG is a knowledge graph generated for each subject with reference to the electronic medical record of each subject, and is generated by the first generation unit 12 described later as an example. The knowledge graph KG is a graph generated by combining the partial knowledge graphs of the subjects, and is generated by the first generation unit 12 described later as an example. The property graph PG is a graph generated with reference to the learned knowledge graph KG, and is generated by the second generation unit 14 described later as an example. The output information OUT is information for output generated by directly or indirectly referring to the property graph PG, and is generated by a third generation unit 16 described later as an example.

### (Control Unit 10A)

As illustrated in FIG. 3, the control unit 10A includes an acquisition unit 11, a first generation unit 12, a learning unit 13, a second generation unit 14, an estimation unit 15, and a third generation unit 16.

### (Acquisition Unit 11)

The acquisition unit 11 acquires the target data TD. Here, the target data may include, as an example, an electronic medical record MR of each of one or a plurality of subjects (patients). The electronic medical record MR may include one or a plurality of texts.

### (First Generation Unit 12)

The first generation unit 12 generates the knowledge graph KG of the target data TD acquired by the acquisition unit 11. Here, as described in the first exemplary example embodiment, the knowledge graph KG is a graph including a plurality of nodes and one or a plurality of links connecting the plurality of nodes, and as an example, has a plurality of types as links and nodes. In the knowledge graph KG, as an example, a node does not have an attribute value other than a label. However, these examples are not intended to limit the present exemplary example embodiment.

Although the specific generation processing of the knowledge graph KG by the first generation unit 12 is not limited to the present exemplary example embodiment, as an example, named entity recognition (NER) and relational extraction (RE) may be applied to one or a plurality of texts included in the target data acquired by the acquisition unit 11, and the knowledge graph may be generated with reference to the results of these processing. More specific generation processing of the knowledge graph KG by the first generation unit 12 will be described later.

### (Learning Unit 13)

The learning unit 13 learns the knowledge graph KG generated by the first generation unit 12. As an example, the learning unit 13 performs machine learning on the knowledge graph generated by the first generation unit 12 by applying knowledge graph embedding to the knowledge graph KG. Here, in knowledge graph embedding, as described in the first exemplary example embodiment,
Referring to triple (h, r, t)=(head-node, link, tail-node), which is the minimum unit constituting the target knowledge graph KG,
Each node and each link are represented (vectorization, embedding vectorization) by a vector, and a method of vectorization is learned so that vectors v_{h,r} representing the head-node and the link approach a vector vₜ representing the tail-node. Here, the vectors v_{h,r} can be expressed as v_{h,r}=vₕ+vᵣ using a vector vₕ representing the head-node and a vector vᵣ representing a link (relation). Specific processing of the learning unit 13 will be described later.

### (Second Generation Unit 14)

The second generation unit 14 generates a property graph PG with reference to the knowledge graph KG learned by the learning unit 13. As an example, the second generation unit 14 generates a property graph PG with reference to an embedding vector indicated by the knowledge graph KG learned by the learning unit 13. Here, as described in the first exemplary example embodiment, as an example, the property graph PG includes:
a plurality of nodes of the same type, each node having one or a plurality of attribute values; and
one or a plurality of links connecting the plurality of nodes.

However, this configuration does not limit the present exemplary example embodiment.

Although the specific generation processing of the property graph by the second generation unit 14 does not limit the present exemplary example embodiment, as an example, the second generation unit 14 performs:
calculating similarity between a plurality of nodes included in the knowledge graph machine-learned by the learning unit 13; and
generating the property graph with reference to the calculated similarity. Here, more specifically, the similarity is calculated with reference to an embedding vector representing each of a plurality of nodes included in the knowledge graph. However, these examples are not intended to limit the present exemplary example embodiment. More specific generation processing of the property graph by the second generation unit 14 will be described later.

### (Estimation Unit 15)

The estimation unit 15 estimates a feature vector of at least one node included in the property graph PG by executing the embedding propagation with reference to the property graph PG generated by the second generation unit 14. Here, the embedding propagation is processing of learning embedding (vectorization) of data, an instance, or the like based on a graph structure representing a relationship between the data and the instance.

In the present exemplary example embodiment, in the embedding propagation executed by the estimation unit 15, the feature amount of each node included in the property graph PG is learned based on the graph structure of the property graph PG. In other words, in the embedding propagation, the manner of embedding each node included in the property graph PG into the feature space (vectorization and feature vector generation) is learned based on the graph structure of the property graph PG. The relationship between the nodes in the property graph PG is taken over as it is in the embedding propagation, and the relationship between the instances (between the nodes) is held even in the learned embedded data. In the embedding propagation, a combination of different expression formats such as categories, floats, free text, and images can be expressed in one consistent embedding space (feature space). In the embedding propagation, it is possible to generate a more beneficial embedding than a simple complementing method for a missing value. A more specific processing performed by the estimation unit 15 is described below.

### (Third Generation Unit 16)

The third generation unit 16 generates the output information OUT with reference to the estimation result by the estimation unit 15. Here, the output information OUT can include information for supporting the decision making of the user (medical worker or the like) of the information processing system 100A. A specific example of the output information OUT will be described later.

### (Flow of Processing in Information Processing Apparatus 1A)

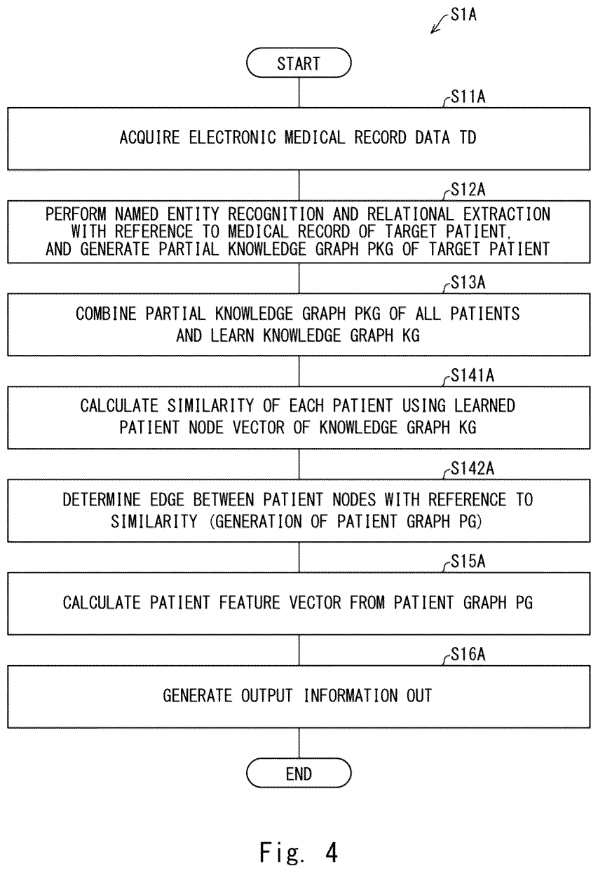

Next, an example of a flow of processing in the information processing apparatus 1A will be described with reference to FIG. 4. FIG. 4 is a flowchart illustrating a flow of processing in the information processing apparatus 1A.

### (Step S11A)

In step S11A, the acquisition unit 11 acquires data of the electronic medical record as the target data TD. Here, the target data TD may include data of electronic medical records of one or a plurality of subjects.

### (Step S12A)

Subsequently, in step S12A, the first generation unit 12 executes the named entity recognition (NER) and the relational extraction (RE) with reference to the medical record of the target patient, and generates (constructs) a partial knowledge graph PKG which is a knowledge graph related to the target patient. More specifically, the first generation unit performs:
recognizing a word (entity) written in a medical record included in the target data TD by the named entity recognition;
extracting a relationship between the recognized words by the relational extraction; and
generating (constructing) the partial knowledge graph PKG with reference to the results of the recognition and extraction.

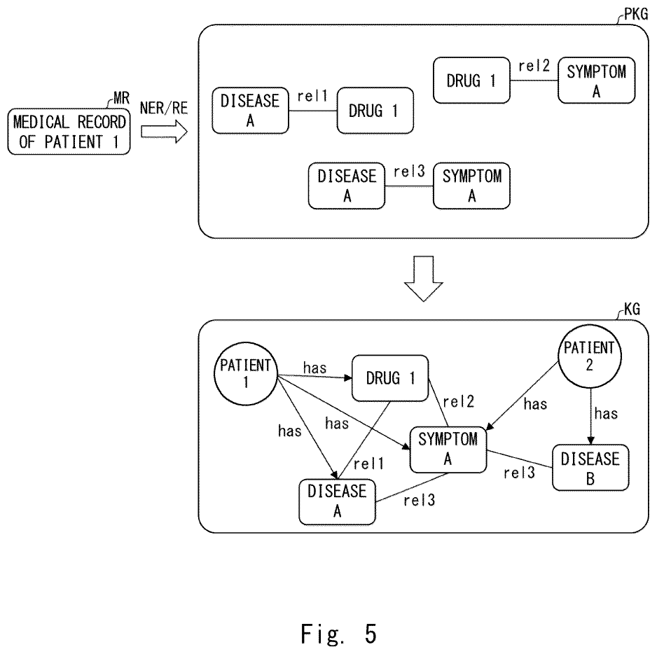

The upper part of FIG. 5 illustrates an example of the partial knowledge graph PKG of a patient 1 which is generated by applying the named entity recognition and the relational extraction to the medical record MR of the patient 1. As illustrated in the upper part of FIG. 5, the partial knowledge graph PKG includes a graph structure represented by each of the three triples:
(disease A, rel1, drug 1);
(drug 1, rel2, symptom A); and
(disease A, rel3, symptom A).

### (Step S13A)

Subsequently, in step S13A, the first generation unit 12 combines the partial knowledge graphs PKG related to the plurality of subjects to generate the knowledge graph KG. More specifically, the first generation unit 12 generates (constructs) the knowledge graph KG reflecting the information of the electronic medical records of all the patients by combining the partial knowledge graph PKG generated in step S12A with the partial knowledge graphs of other patients. The lower part of FIG. 5 illustrates an example of the knowledge graph KG obtained by combining the partial knowledge graph PKG of the target patient illustrated in the upper part of FIG. 5 with the knowledge graphs of other patients. In the knowledge graph KG, the node indicating the patient 1 and each of a drug 1, a disease A, and a symptom A are connected by links, and the node indicating the patient 2 and each of the symptom A and a disease B are connected by links.

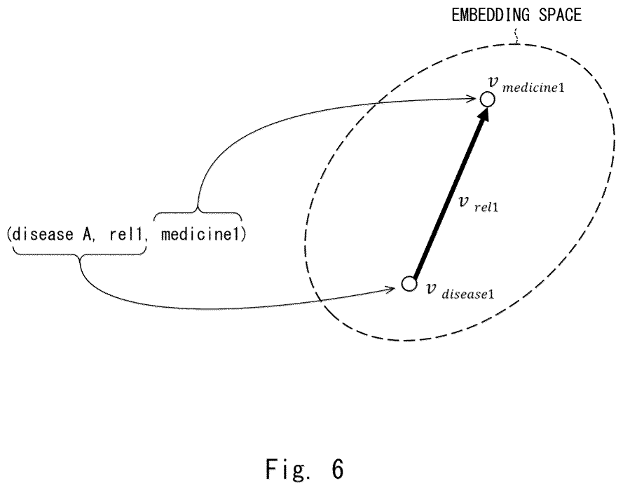

Subsequently, in this step S13A, the learning unit 13 learns the knowledge graph KG generated by the first generation unit 12. Here, the learning of the knowledge graph KG is performed by knowledge graph embedding as described above. FIG. 6 illustrates an example of knowledge graph embedding by the learning unit 13. By knowledge graph embedding, the way of embedding a target triple (disease1, rel1, medicine1) into an embedding space (feature space) is learned. As an example, the way of embedding is learned such that a vector v_{disease1} indicating the head of the triple, a vector vᵣₑₗ₁ indicating the link of the triple, and a vector v_{medicine1} indicating the tail of the triple satisfy the following relationship:
v_{medicine1}=v_{disease1}+vᵣₑₗ₁. By such learning, there is a property that the vector representation becomes close to a node having a similar way of connection with another node on the knowledge graph.

### (Steps S141A and S142A)

Subsequently, in step S141A, the second generation unit 14 calculates the similarity of each patient using the embedding vector of each patient node included in the knowledge graph KG learned in step S13A. Then, in step S142A, the second generation unit 14 determines an edge (link) between the patient nodes with reference to the similarity calculated in step S141A.

In other words, the second generation unit 14 refers to the similarity calculated in step S141A and determines whether a certain patient node and another patient node are connected by a link.

As an example, in a case where the similarity between a certain patient node and another patient node is equal to or more than a predetermined threshold, the second generation unit 14 connects the certain patient node and the other patient node by a link. By performing such processing, the second generation unit 14 generates the property graph PG.

The property graph PG generated in this step is also referred to as a patient graph PG.

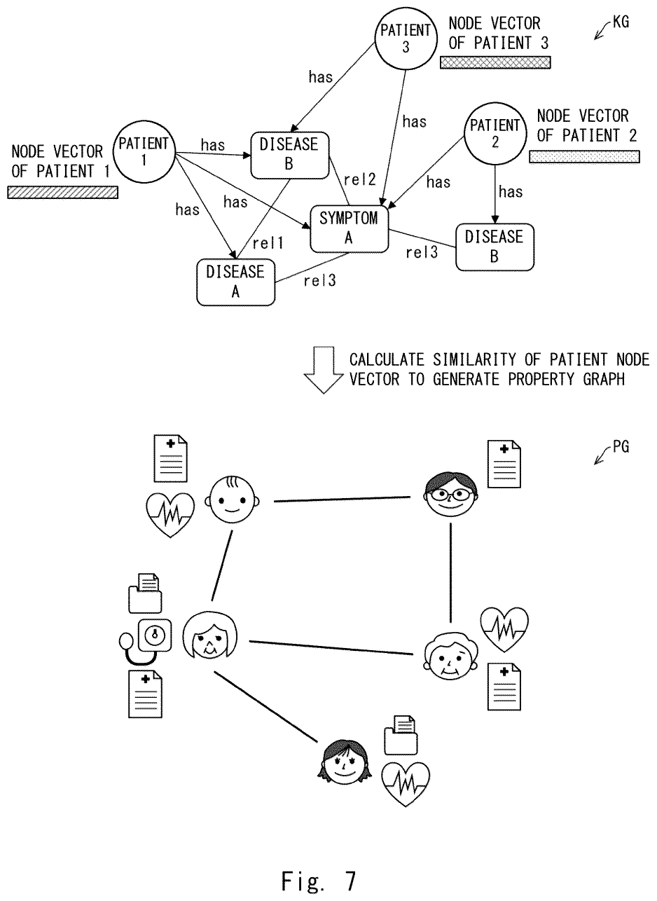

The upper part of FIG. 7 schematically illustrates that the knowledge graph KG generated and learned in step S13A is referred to in step S141A, and the similarity of each patient is calculated using the embedding vector of each patient node in step S141A. The lower part of FIG. 7 illustrates an example of the patient graph PG generated in step S142A with reference to the similarity of each patient.

### (Step S15A)

Subsequently, in step S15A, the estimation unit 15 calculates (estimates) the feature vector of the target patient with reference to the patient graph PG. In other words, the estimation unit 15 estimates the feature amount of the node of the target patient included in the patient graph PG. The processing is performed by embedding propagation as an example.

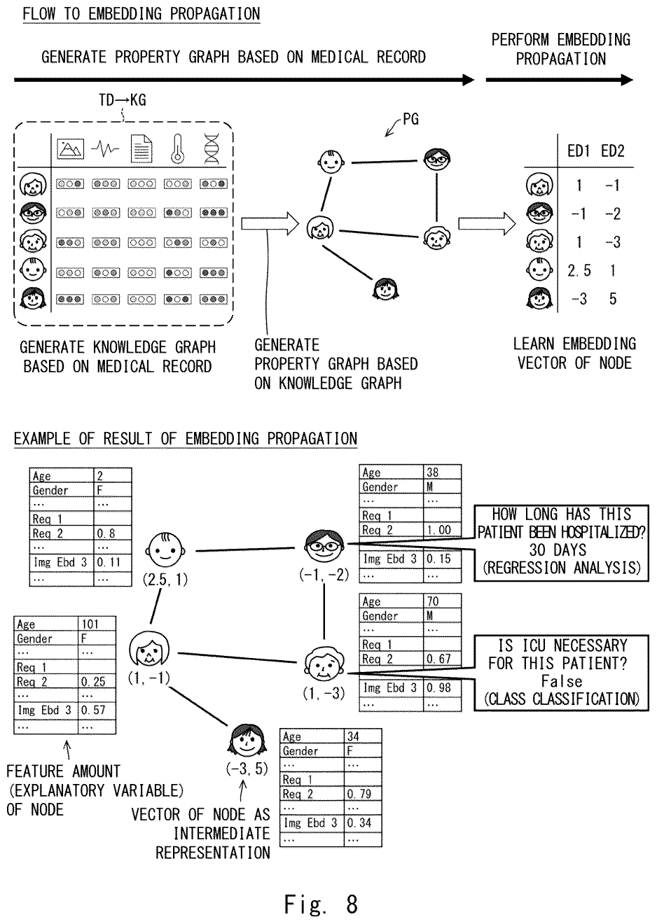

The upper part of FIG. 8 illustrates an example in which the knowledge graph KG is generated based on the medical record in steps S11A to S13A, the property graph PG is generated from the knowledge graph KG in steps S141A to S142A, and the embedding propagation is applied to the generated property graph PG in this step.

The lower part of FIG. 8 illustrates an example of a result of the embedding propagation executed in this step. As illustrated in the lower part of FIG. 8, the node of each patient is accompanied by feature amounts including a plurality of elements such as Age, Gender, Req1, and Req2, and these feature amounts include information learned and complemented by the embedding propagation. These feature amounts are expressed as feature vectors in the feature space. As exemplarily illustrated in the lower part of FIG. 8, the estimation unit 15 can also execute processing such as regression analysis or class classification as a part of the embedding propagation or as processing with reference to the result of the embedding propagation.

### (Step S16A)

Subsequently, in step S16A, the third generation unit 16 generates the output information OUT with reference to the estimation result by the estimation unit 15 (in other words, the result of the embedding propagation). The output information OUT may include, as an example,
Information for supporting decision-making of a user (medical worker or the like) of the information processing system 100A,
Information to be output to an internal device or an external device of the information processing system 100A (information for presentation or control information), and the like. The output information OUT may include a result of regression analysis, class classification, or the like executed with reference to the result of the embedding propagation.

### (Effect of Information Processing Apparatus 1A)

As described above, the information processing apparatus 1A adopts a configuration of
acquiring target data TD;
generating a knowledge graph KG from the target data TD; and
machine-learning the knowledge graph KG;
generating a property graph PG with reference to the machine-learned knowledge graph KG. According to the above configuration, since the knowledge graph KG is generated from the target data TD, the generated knowledge graph KG is subjected to machine learning, and the property graph PG is generated with reference to the machine-learned knowledge graph KG, it is possible to generate the property graph PG suitably reflecting the relationship between the entities included in the target data TD.

The property graph PG generated in this manner can be suitably referred to in the embedding propagation executed by the estimation unit 15 described above.

In the information processing apparatus 1A, the output information OUT is generated with reference to the result of the embedding propagation. Therefore, it is possible to generate the output information OUT suitably reflecting the relationship between the entities included in the target data TD.

### (Supplementary Information Related to Effects)

As described above, according to the information processing apparatus 1A, it is possible to generate the property graph PG suitably reflecting the relationship between the entities included in the target data TD. As a graph configuration method, a method (so-called kNN method) is also known in which an arbitrary combination is selected from node attribute values, similarity is calculated with respect to the selected attribute values, and k nodes having the closest similarity at each node are connected. However, in a case where there is a complicated relationship between entities (attribute values) included in the target data TD, in the kNN method, in order to construct a graph reflecting the relationship between the attribute values, it is necessary to select the attribute values in consideration of the relationship, which is troublesome and not realistic. For example, in a case where the number of types of attribute values included in the target data TD is 30, the number of cases of selecting two types from these attribute values and considering the relationship is ₃₀C₂, which requires a large amount of effort.

On the other hand, according to the information processing apparatus 1A according to the present exemplary example embodiment, since the knowledge graph KG is automatically generated from the target data TD, the generated knowledge graph KG is subject to machine learning, and the property graph PG is automatically generated with reference to the machine-learned knowledge graph KG, it is possible to generate the property graph PG suitably reflecting the relationship between the entities included in the target data TD without requiring the above-described effort.

### Third Example Embodiment

A second exemplary example embodiment that is an example of an example embodiment of the present disclosure will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technology illustrated in each of the drawings referred to for describing the present exemplary example embodiment can also be adopted in another exemplary example embodiment included in the present disclosure within a range in which no particular technical problem occurs.

### (Configuration of Information Processing System 100B)

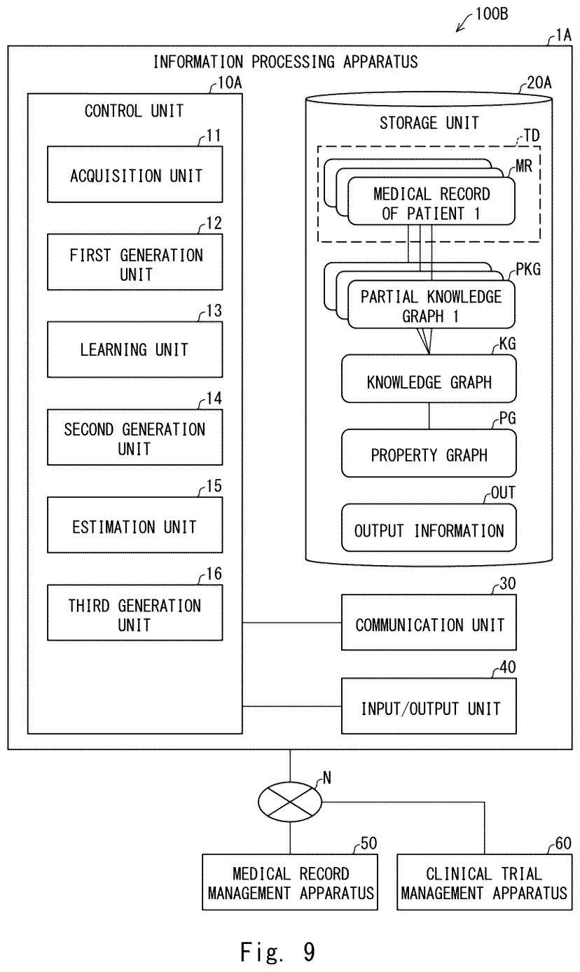

A configuration of an information processing system 100B according to the present exemplary example embodiment will be described with reference to FIG. 9. FIG. 9 is a block diagram illustrating the configuration of the information processing system 100B. As illustrated in FIG. 9, the information processing system 100B includes an information processing apparatus 1A, a medical record management apparatus 50, and a clinical trial management apparatus 60 connected to the information processing apparatus 1A via a network N. The information processing apparatus 1A and the medical record management apparatus 50 are similar to those of the second exemplary example embodiment, and redundant description is omitted since they have already been described.

### (Clinical Trial Management Apparatus 60)

The clinical trial management apparatus 60 manages implementation of the clinical trial. As an example, the clinical trial management apparatus 60 may acquire or manage:
Data on clinical trial type;
Data on drugs used in each clinical trial;
Data on candidates for each clinical trial (clinical trial candidates);
Pre-clinical trial data for subjects of each clinical trial (clinical trial subjects);
In-clinical trial data on subjects of each clinical trial;
Post-clinical trial data on subjects of each clinical trial; and the like. As an example, the clinical trial management apparatus 60 may be configured to generate output data (clinical trial report or the like) with reference to the above-described data.

### (Processing Example of Information Processing System 100B)

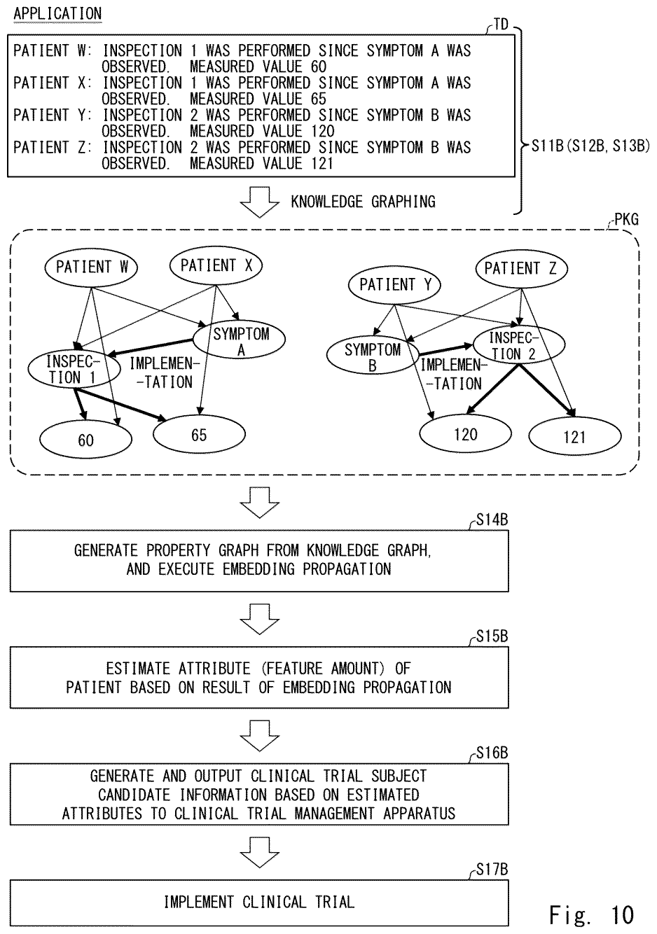

FIG. 10 is a diagram schematically illustrating an example of the flow of processing by the information processing system 100B.

### (Step S11B (S12B, S13B))

In step S11B (S12B, S13B), the information processing apparatus 1A generates the partial knowledge graph PKG and the knowledge graph KG with reference to the target data TD by processing similar to steps S11B, S12B, and S13B described in the second exemplary example embodiment.

### (Step S14B)

Subsequently, in step S14B, the information processing apparatus 1A generates a property graph (patient graph) PG from the knowledge graph KG by processing similar to that in steps S141A and S142A described in the second exemplary example embodiment, and executes embedding propagation.

### (Step S15B)

Subsequently, in step S15B, the attribute (feature vector and feature amount) of each patient is calculated (estimated) from the patient graph PG with reference to the result of the embedding propagation by processing similar to step S15A described in the second exemplary example embodiment.

### (Step S16B)

Subsequently, in step S16B, the third generation unit 16 of the information processing apparatus 1A generates clinical trial subject candidate information based on the attribute of each patient estimated in step S15B, and outputs the clinical trial subject candidate information to the clinical trial management apparatus 60. Here, the clinical trial subject candidate information includes information (patient ID and the like) for specifying a candidate relating to the target clinical trial.

### (Step S17B)

Then, in step S17B, the clinical trial management apparatus 60 refers to the clinical trial subject candidate information supplied from the information processing apparatus 1A in step S16B and executes processing related to the clinical trial. As an example, the clinical trial management apparatus 60 refers to the ID of the clinical trial candidate included in the clinical trial subject candidate information and acquires data on the clinical trial candidate from the medical record management apparatus 50.

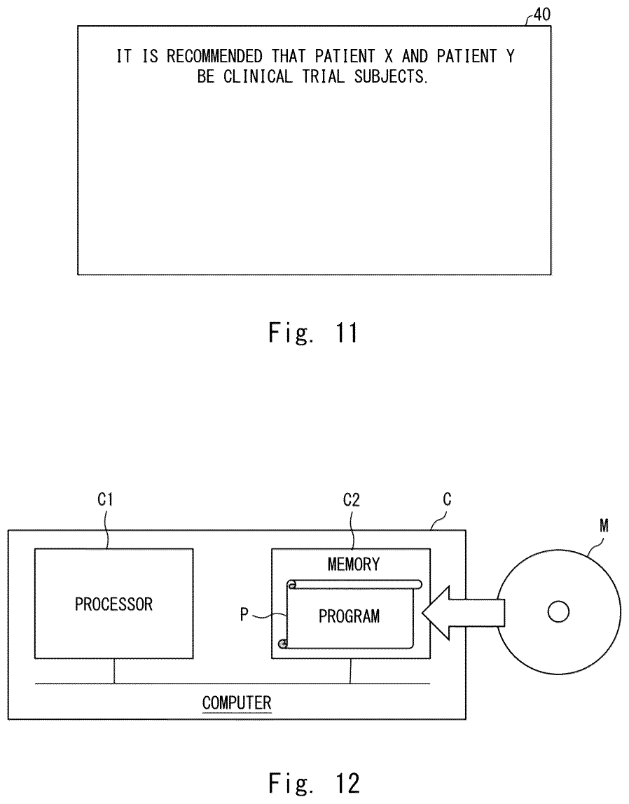

In step S16B, the third generation unit 16 of the information processing apparatus 1A may visually present the candidate related to the target clinical trial to the user (medical worker or the like) of the information processing system 100B via the input/output unit 40. As an example, the third generation unit 16 may output display information such as “It is recommended to set the patient X and the patient Y as clinical trial subjects” as illustrated in FIG. 11 via the display included in the input/output unit 40.

According to the information processing system 100B according to the present exemplary example embodiment, the following effects are obtained such that:
A patient graph PG reflecting a relationship between words written in a medical record document (target data TD) of a patient can be constructed; and
By using the constructed patient graph PG, patient attribute estimation and trial conformity determination can be accurately performed as a downstream task. Therefore, according to the information processing system 100B, as an example, it is possible to suitably execute extraction of a clinical trial subject candidate that has conventionally required cost and time.

### [Example of Implementation by Software]

Some or all of the functions of the information processing apparatuses 1 and 1A (hereinafter, also referred to as “each of the above apparatuses”) may be implemented by hardware such as an integrated circuit (IC chip) or may be implemented by software.

In the latter case, each of the above apparatuses is implemented by, for example, a computer that executes a command of a program which is software for implementing each function. An example of such a computer (hereinafter, referred to as a computer C) is illustrated in FIG. 12. FIG. 12 is a block diagram illustrating a hardware configuration of the computer C functioning as each of the above apparatuses.

The computer C includes at least one processor C1 and at least one memory C2. A program P causing the computer C to operate as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### [Supplementary Information A]

The present disclosure includes technologies described in the following Supplementary Notes. However, the present disclosure is not limited to the techniques described in the following Supplementary Notes, and various modifications can be made within the scope described in the claims.

### (Supplementary Note A1)

An information processing apparatus including:
an acquisition means for acquiring target data;
a first generation means for generating a knowledge graph from the target data;
a learning means for performing machine learning on the knowledge graph; and
a second generation means for generating a property graph with reference to the knowledge graph machine-learned by the learning means.

### (Supplementary Note A2)

The information processing apparatus according to Supplementary Note A1, in which the second generation means is configured to execute: calculating similarity between a plurality of nodes included in the knowledge graph machine-learned by the learning means, and generating the property graph with reference to the calculated similarity.

### (Supplementary Note A3)

The information processing apparatus according to Supplementary Note A1 or A2, including an estimation means for estimating a feature vector of at least one node included in the property graph by executing embedding propagation with reference to the property graph.

### (Supplementary Note A4)

The information processing apparatus according to Supplementary Note A3, including a third generation means for referring to an estimation result by the estimation means to generate information for supporting user's decision making.

### (Supplementary Note A5)

The information processing apparatus according to any one of Supplementary Notes A1 to A4, in which the target data includes medical records of one or a plurality of subjects.

### (Supplementary Note A6)

The information processing apparatus according to any one of Supplementary Notes A1 to A5, in which knowledge graph generation processing by the first generation means includes: a process of generating a partial knowledge graph that is a knowledge graph related to a certain subject with reference to results obtained by executing named entity recognition and relational extraction with reference to one or a plurality of texts included in a medical record of the subject.

### (Supplementary Note A7)

The information processing apparatus according to Supplementary Note A6, in which knowledge graph generation processing by the first generation means includes: a process of generating the knowledge graph by combining partial knowledge graphs related to a plurality of subjects.

### (Supplementary Note A8)

The information processing apparatus according to any one of Supplementary Notes A1 to A7, in which the property graph includes:
a plurality of nodes of a same type, each node having one or a plurality of attribute values; and
one or a plurality of links connecting the plurality of nodes.

### [Supplementary Information B]

The present disclosure includes technologies described in the following Supplementary Notes. However, the present disclosure is not limited to the techniques described in the following Supplementary Notes, and various modifications can be made within the scope described in the claims.

### (Supplementary Note B1)

An information processing method including:
an acquisition process of acquiring, by at least one processor, target data;
a first generation process of generating, by the at least one processor, a knowledge graph from the target data;
a learning process of performing, by the at least one processor, machine learning on the knowledge graph; and
a second generation process of generating, by the at least one processor, a property graph with reference to the knowledge graph machine-learned by the learning process.

### (Supplementary Note B2)

The information processing method according to Supplementary Note B1, in which the second generation process includes: calculating similarity between a plurality of nodes included in the knowledge graph machine-learned in the learning process, and generating the property graph with reference to the calculated similarity.

### (Supplementary Note B3)

The information processing method according to Supplementary Note B1 or B2, including an estimation process of estimating, by the at least one processor, a feature vector of at least one node included in the property graph by executing embedding propagation with reference to the property graph.

### (Supplementary Note B4)

The information processing method according to Supplementary Note B3, including a third generation process of referring to, by the at least one processor, an estimation result by the estimation process to generate information for supporting user's decision making.

### (Supplementary Note B5)

The information processing method according to any one of Supplementary Notes B1 to B4, in which the target data includes medical records of one or a plurality of subjects.

### (Supplementary Note B6)

The information processing method according to any one of Supplementary Notes B1 to B5, in which knowledge graph generation processing by the first generation process includes: a process of generating, by the at least one processor, a partial knowledge graph that is a knowledge graph related to a certain subject with reference to results obtained by executing named entity recognition and relational extraction with reference to one or a plurality of texts included in a medical record of the subject.

### (Supplementary Note B7)

The information processing method according to Supplementary Note B6, in which knowledge graph generation processing by the first generation process includes: a process of generating the knowledge graph by combining partial knowledge graphs related to a plurality of subjects.

### (Supplementary Note B8)

The information processing method according to any one of Supplementary Notes B1 to B7, in which the property graph includes:
a plurality of nodes of a same type, each node having one or a plurality of attribute values; and
one or a plurality of links connecting the plurality of nodes.

### [Supplementary Information C]

The present disclosure includes technologies described in the following Supplementary Notes. However, the present disclosure is not limited to the techniques described in the following Supplementary Notes, and various modifications can be made within the scope described in the claims.

### (Supplementary Note C1)

An information processing program for causing a computer to function as an information processing apparatus, in which the computer functions as:
an acquisition means for acquiring target data;
a first generation means for generating a knowledge graph from the target data;
a learning means for performing machine learning on the knowledge graph; and
a second generation means for generating a property graph with reference to the knowledge graph machine-learned by the learning means.

### (Supplementary Note C2)

The information processing program according to Supplementary Note C1, in which the second generation means is configured to execute: calculating similarity between a plurality of nodes included in the knowledge graph machine-learned by the learning means, and generating the property graph with reference to the calculated similarity.

### (Supplementary Note C3)

The information processing program according to Supplementary Note C1 or C2, in which the computer is caused to execute: an estimation process of estimating a feature vector of at least one node included in the property graph by executing embedding propagation with reference to the property graph.

### (Supplementary Note C4)

The information processing program according to Supplementary Note C3, in which the computer is caused to execute: a third generation process of referring to an estimation result by the estimation means to generate information for supporting user's decision making.

### (Supplementary Note C5)

The information processing program according to any one of Supplementary Notes C1 to C4, in which the target data includes medical records of one or a plurality of subjects.

### (Supplementary Note C6)

The information processing program according to any one of Supplementary Notes C1 to C5, in which knowledge graph generation processing by the first generation means includes: a process of generating a partial knowledge graph that is a knowledge graph related to a certain subject with reference to results obtained by executing named entity recognition and relational extraction with reference to one or a plurality of texts included in a medical record of the subject.

### (Supplementary Note C7)

The information processing program according to Supplementary Note C6, in which knowledge graph generation processing by the first generation means includes: a process of generating the knowledge graph by combining partial knowledge graphs related to a plurality of subjects.

### (Supplementary Note C8)

The information processing program according to any one of Supplementary Notes C1 to C7, in which the property graph includes:
a plurality of nodes of a same type, each node having one or a plurality of attribute values; and
one or a plurality of links connecting the plurality of nodes.

### [Supplementary Information D]

The present disclosure includes technologies described in the following Supplementary Notes. However, the present disclosure is not limited to the techniques described in the following Supplementary Notes, and various modifications can be made within the scope described in the claims.

### (Supplementary Note D1)

An information processing apparatus including: at least one processor,
in which the at least one processor is configured to execute:
an acquisition process of acquiring target data;
a first generation process of generating a knowledge graph from the target data;
a learning process of performing machine learning on the knowledge graph; and
a second generation process of generating a property graph with reference to the knowledge graph machine-learned by the learning process.

The information processing apparatus may further include a memory. The memory may store a program for causing the at least one processor to execute each of the processing.

### (Supplementary Note D2)

The information processing apparatus according to Supplementary Note D1, in which in the second generation process, similarity between a plurality of nodes included in the knowledge graph machine-learned in the learning process is calculated, and the property graph is generated with reference to the calculated similarity.

### (Supplementary Note D3)

The information processing apparatus according to Supplementary Note D1 or D2, in which the at least one processor is configured to execute: an estimation process of estimating a feature vector of at least one node included in the property graph by executing embedding propagation with reference to the property graph.

### (Supplementary Note D4)

The information processing apparatus according to Supplementary Note D3, the at least one processor is configured to execute: a third generation process of referring to, by the at least one processor, an estimation result by the estimation process to generate information for supporting user's decision making.

### (Supplementary Note D5)

The information processing apparatus according to any one of Supplementary Notes D1 to D4, in which the target data includes medical records of one or a plurality of subjects.

### (Supplementary Note D6)

The information processing apparatus according to any one of Supplementary Notes D1 to D5, in which knowledge graph generation processing by the first generation process includes: by the at least one processor, a process of generating a partial knowledge graph that is a knowledge graph related to a certain subject with reference to results obtained by executing named entity recognition and relational extraction with reference to one or a plurality of texts included in a medical record of the subject.

### (Supplementary Note D7)

The information processing apparatus according to Supplementary Note D6, in which knowledge graph generation processing by the first generation process includes: a process of generating the knowledge graph by combining partial knowledge graphs related to a plurality of subjects.

### (Supplementary Note D8)

The information processing apparatus according to any one of Supplementary Notes D1 to D7, in which the property graph includes:
a plurality of nodes of a same type, each node having one or a plurality of attribute values; and
one or a plurality of links connecting the plurality of nodes.

### [Supplementary Information E]

The present disclosure includes technologies described in the following Supplementary Note. However, the present disclosure is not limited to the techniques described in the following Supplementary Note, and various modifications can be made within the scope described in the claims.

### (Supplementary Note E1)

A non-transitory recording medium having stored therein an information processing program for causing a computer to function as an information processing apparatus, in which the program causes the computer to execute:
an acquisition process of acquiring target data;
a first generation process of generating a knowledge graph from the target data;
a learning process of performing machine learning on the knowledge graph; and
a second generation process of generating a property graph with reference to the knowledge graph machine-learned by the learning process.

Some or all of elements (e.g., structures and functions) specified in Supplementary Notes A2 to A8 dependent on Supplementary Note A1 may also be dependent on Supplementary Note E1 in dependency similar to that of Supplementary Notes A2 to A8 on Supplementary Note A1. Some or all of elements specified in any of Supplementary Notes may be applied to various types of hardware, software, and recording means for recording software, systems, and methods.

1. An information processing apparatus comprising:
at least one memory storing instructions, and
at least one processor configured to execute the instructions to;
acquire target data;
generate a knowledge graph from the target data;
perform machine learning on the knowledge graph;
calculate similarity between a plurality of nodes included in the machine-learned knowledge graph;
generate a property graph with reference to the calculated similarity; and
estimate a feature vector of at least one node included in the property graph by executing embedding propagation with reference to the property graph.

2. The information processing apparatus according to claim 1, wherein the at least one processor is further configured to execute the instructions to refer to an estimation result to generate information for supporting user's decision making.

3. The information processing apparatus according to claim 1, wherein the target data includes medical records of one or a plurality of subjects.

4. The information processing apparatus according to claim 3, wherein knowledge graph generation processing includes: a process of generating a partial knowledge graph that is a knowledge graph related to a certain subject with reference to results obtained by executing named entity recognition and relational extraction with reference to one or a plurality of texts included in a medical record of the subject.

5. The information processing apparatus according to claim 4, wherein knowledge graph generation processing includes: a process of generating the knowledge graph by combining partial knowledge graphs related to each of a plurality of subjects.

6. The information processing apparatus according to claim 1, wherein the property graph includes:
a plurality of nodes of a same type, each node having one or a plurality of attribute values; and
one or a plurality of links connecting the plurality of nodes.

7. An information processing method causing one or more processors to execute:
acquiring target data;
generating a knowledge graph from the target data;
machine-learning the knowledge graph;
calculating similarity between a plurality of nodes included in the machine-learned knowledge graph;
generating a property graph with reference to the calculated similarity; and
estimating a feature vector of at least one node included in the property graph by executing embedding propagation with reference to the property graph.

8. A non-transitory computer-readable medium storing a program for causing a computer to execute processing comprising:
acquiring target data;
generating a knowledge graph from the target data;
performing machine learning on the knowledge graph;
calculating similarity between a plurality of nodes included in the machine-learned knowledge graph;
generating a property graph with reference to the calculated similarity; and
estimating a feature vector of at least one node included in the property graph by executing embedding propagation with reference to the property graph.
